(19) United States
(12) Patent Application Publication
(10) Pub. No.: US 2023/0166923 A1
(43) Pub. Date: Jun. 1, 2023

(54) TRANSPORT DEVICE WITH LOW-TENSION FOIL GUIDING FOR THE PRODUCTION OF BATTERIES

(71) Applicant: BATTRION AG, Duebendorf (CH)

(72) Inventor: Martin EBNER, Kuesnacht (CH)

(73) Assignee: BATTRION AG, Duebendorf (CH)

(21) Appl. No.: 18/053,815

(22) Filed: Nov. 9, 2022

(30) Foreign Application Priority Data
Dec. 1, 2021 (DE) 10 2021 131 668.5

(51) Int. Cl. B65G 47/84; H01M 4/04; H01M 4/587; H01M 4/133; H01M 4/1393

(52) U.S. Cl. CPC B65G 47/84; H01M 4/0404; H01M 4/587; H01M 4/133; H01M 4/1393

(57) ABSTRACT

Proposed is a transport device for transporting a carrier in the form of a foil for producing electrodes for energy accumulators, in particular electrodes for lithium-ion batteries, having at least two rollers on which the carrier is able to be borne, and of which at least one of the rollers is provided with a drive so as to, by rotation of the driven roller, move the carrier along the longitudinal extent thereof, and transport the carrier from roller to roller. Provided for improving the manufacturing quality is a drive device for generating an additional force which facilitates transport and which for generating an alternating magnetic field has an alternating field generator that generates a temporally changing magnetic field so as to induce eddy currents in the carrier, and so as to exert a Lorentz force on the charges flowing in the carrier as a consequence of the eddy currents.

This application claims the benefit under 35 USC § 119(a)-(d) of German Application No. 10 2021 131 668.5 filed Dec. 1, 2021, the entirety of which is incorporated herein by reference.

### FIELD OF THE INVENTION

The present invention relates to a transport device for transporting a carrier in the form of a foil for producing electrodes for energy accumulators, in particular, electrodes for lithium-ion batteries.

### BACKGROUND OF THE INVENTION

In the production of electrodes for batteries such as, for example, lithium-ion batteries, carriers which are present as a foil are typically provided with a coating. This coating comprises, for example, graphite particles which can be oriented in a magnetic field that is variable in terms of time or location, respectively, so as to keep the distances which the flowing ions travel when charging or discharging the cell as short as possible. Besides the graphite particles, other materials such as, for example, silicon particles or silicon oxide particles, mixtures of different types of graphite, as well as binders, conductivity additives and surface modifiers may also be included. It has been demonstrated in the prior art that the coating of the carrier webs in the manufacturing process can at times have quality shortcomings which at times have mechanical causes. Creasing to which the carrier is subjected can thus arise, this impeding or rendering impossible the further processing into lithium-ion batteries.

### SUMMARY OF THE INVENTION

It is an object of the present invention to provide a corresponding transport device by way of which the production process of electrodes can be improved in terms of quality and which enables a higher yield and faster web speeds.

Carriers in the form of foils are transported by the transport device according to the present invention during the production of electrodes for energy accumulators. Electrodes for lithium-ion batteries are typically produced while using coated carriers of this type. The carriers per se comprise an electrically conducting material, for example, a copper foil. The transport device conveys the carriers, or the foil webs serving as carriers, respectively, in a so-called roller-to-roller process, i.e. the transport device comprises at least two rollers on which the carrier can be borne. At least one of the rollers here is provided with a drive so as to, by rotation of the driven roller, move the carrier along the longitudinal extent thereof and thus transport the carrier from roller to roller.

As has been demonstrated in the context of the inventive step, intense mechanical forces can act on the carrier during transport and in this way at times be responsible for poorer results in terms of quality. As has been demonstrated, these forces are caused by the actual roller-to-roller transport procedure as well as by the processes of orienting the particles in the coating.

During transport in the roller-to-roller process, tension in the direction of movement acts on the carrier web, the tension potentially reaching the stress limits of the carriers and/or of the coating plant specifically at high carrier speeds and in the case of long webs. Furthermore, a high web tension can lead to creasing in the carrier. Moreover, the forces that act on the carrier are in principle not constant overall but it has to be expected that the forces peak in the center of the carrier, at least by way of the component of the forces along the direction of movement, or the longitudinal extent of the web, respectively, and increase across the length of the coating plant. A non-uniform distribution of the forces may lead to tension in the foil and thus to bulging of the carrier.

Besides the mechanical stress that initially arises purely by virtue of the transport procedure, the orienting process per se can also lead to mechanical tension in the carrier. Magnetic fields which are variable in terms of time or location are present for orienting the particles present in the coating, the carrier moving in the magnetic fields. Eddy currents are created in the carrier by virtue of the magnetic induction, the magnetic field of the eddy currents interacting with the above-mentioned magnetic fields of the orienting device. The effect of force which results therefrom acts counter to the direction of movement and brakes the carrier in terms of the movement of the latter. The web tension acting on the carrier is thus even amplified by this additional effect. Moreover, the orienting process can lead to an anisotropic drying procedure being formed, in which the coating has a higher shrinkage in the transverse direction than in the direction of depth or in the longitudinal direction, for example.

In order for the web tension to be equalized, the web is impinged with an additional force which is, however, directed such that the additional force can at least partially equalize those forces that lead to the undesirable web tensions. This force is generated by a drive device and corresponds to an additional force that facilitates transport.

For generating the additional force, the drive device comprises an alternating field generator which generates an alternating magnetic field that temporally changes and to which the electrically conducting carrier is exposed such that eddy currents are induced in the carrier. A Lorentz force, which is transmitted to the carrier, acts on the charges flowing as a result of the eddy currents in the magnetic field. This additional driving force can counteract the braking force, the latter being caused by the fundamentally same effect and being generated by the orienting device.

The drive device proposed according to the present invention moreover has the advantage that the force exerted by the latter on the carrier is also (steplessly) adjustable and able to be precisely feedback-controlled if required. The temporal change of the magnetic flux can be influenced; the frequency can be increased, for example. It is also conceivable for the alternating field generator to comprise a rotor, the frequency of the latter being increased.

In one particularly preferred refinement of the present invention, the alternating field generator does not contact the carrier but operates in a non-contacting manner. The coating applied to the carrier has often not yet cured or dried during orientation. In the case of a (still) soft or liquid coating, it is however risky to exert a force by way of direct mechanical contact because the coating may be damaged as a result. This is even more relevant if the carrier has been coated on both sides. Exerting an additional driving force in a non-contacting manner on the carrier can advantageously be initiated by a magnetic field which is variable in terms of time and/or location.

To this end, the alternating field generator can be compact and be integrated in a space-saving manner in one of the rollers, or replace one roller, respectively. Such a variant of embodiment of the present invention also makes it possible for the alternating field generator to be moved as close as possible to the carrier. In this way, the field and also the force acting on the carrier can be maximized.

It has already been described that an orienting device for orienting the particles can be integrated in the transport device. The particles in the coating are oriented by the orienting device. In the production of electrodes for lithium-ion batteries, electrochemically active particles such as, for example, graphite particles, are oriented. A magnetic field which is variable in terms of time/location can in turn be generated for this purpose. The orientation of the particles during transport can thus advantageously take place immediately after the coating, when the coating is still soft and the particles can therefore move or rotate more easily.

The orienting device also generates alternating fields and thus eddy currents in the carrier plane. The preferred direction of the alternating fields is in particular transverse to the transport direction, or at a defined angle in relation to the transport direction, respectively.

A fundamentally simple implementation provides that the alternating field generator is configured as a rotor. In this instance, permanent magnets can be disposed on the rotor circumference. The rotor can then readily change the alternating field by adjusting the frequency.

In one embodiment of the present invention, the permanent magnets that are disposed along the rotor circumference can be disposed in a Halbach array, i.e. the permanent magnets in the clockwise direction run in an alternating manner radially inward, tangentially in the clockwise direction, radially outward and tangentially in the counter-clockwise direction, etc. In this instance, the fields in the interior can in each case run tangentially or radially to the rotation path in the rotation plane.

The permanent magnets per se can in turn have the shape of a cuboid or of a hollow cylinder, for example.

Instead of being disposed in a Halbach array, the permanent magnets can alternatively also be disposed in a multipolar configuration, i.e. lie radially toward the inside and the outside.

The rotor, which supports the permanent magnets, can be configured as a magnetic roller and in terms of construction correspond to the rotor of a permanent-magnet motor. To this end, the permanent magnets can be disposed on or about a cylinder, respectively. In an embodiment of this type, the rotor likewise comprises a rotor drive device which can be configured as a motor with a timing belt for transmitting the rotating movement, for example.

In order to be able to adapt the additionally acting driving force to the individual production process, the rotor drive device in one preferred refinement of the present invention can vary the rotating speed of the rotor. Since the transport speed, or the carrier speed, respectively, in the production may differ, it is advantageous to adapt the rotating speed to the transport speed or carrier speed, respectively. In the coating and orienting procedures, the manufacturing parameters have to be very precisely adjusted in order to adjust the drying rate in terms of the orientation as a function of the properties of the coating, the shape and size of the particles, and the viscosity of the coating material. To this end, the alternating fields in terms of location or time are then adjusted conjointly with the carrier speed. The rotating speed can thus be adjusted at a predetermined ratio to the transport speed, so as to permit a defined additional force to act on the carrier.

In one embodiment of the present invention, the rotor can be mounted on a static shaft. For example, the shaft can be disposed at a location along the transport section that is favorable for the transmission of force. The mounting of the rotor on the shaft can be performed by way of roller bearings such that the rotor can rotate with only very little friction.

In principle however, in one variant of embodiment of the present invention it is also conceivable for the stator of a linear motor to be used as the alternating field generator, not least because the linear motor can supply a driving force for linear transport. This additional driving force can be oriented such that the latter counteracts the tension. The stator of the linear motor comprises, for example, an iron core, or a laminated sheet package of laminated individual sheets by way of which parasitic eddy currents can be suppressed, respectively. Grooves in which coils are situated are incorporated in the iron core, or in the laminated sheet package, respectively. The coils are passed through by a phase-delayed alternating current; i.e. at least three coils are typically present along the transport section, a 3-phase alternating current flowing through the coils. However, a linear drive can have the advantage that high accelerations, rapid feedback-control, as well as high forces can be implemented by way of the linear drive. Moreover, in terms of a linear movement, a linear motor can also be considered to be a direct drive, as the stator drives the carrier like a rotor. The stator of the linear motor does not require any rotating or moving parts, thus no parts that are exposed to friction.

However, the embodiment that comprises a permanent magnet roller is distinguished in that the embodiment has a low energy requirement and leads to minor heat generation.

In one particularly preferred embodiment, the additional force can be chosen such that the web tension, which is created when orienting particles as a consequence of magnetic induction and would otherwise lead to warping of the carrier, is equalized. Such an embodiment can, in particular, minimize or prevent creasing of the carrier as a consequence of the web tension.

### BRIEF DESCRIPTION OF THE DRAWINGS

Exemplary embodiments of the present invention are illustrated in the drawings and are explained in more detail below with further details and advantages being given.

FIG. 1 shows a schematic illustration of part of the transport device according to the present invention (in a lateral view);

FIG. 2 shows a schematic illustration of the transport device shown in FIG. 1, in a plan view from above;

FIG. 3 shows a schematic illustration of a magnetic roller as an alternating field generator; and

FIG. 4 shows a schematic illustration of a linear motor stator as an alternating field generator.

### DETAILED DESCRIPTION OF THE INVENTION

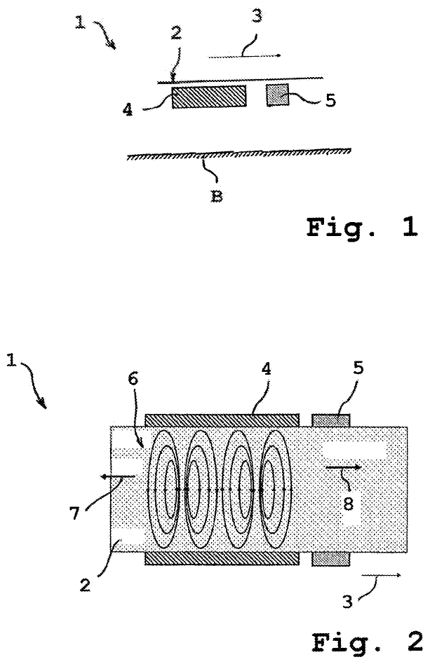

FIG. 1 shows a lateral view of a schematic illustration of a transport device 1, in which a carrier 2 in the form of a foil that is used in the production of electrodes for lithium-ion batteries is moved in a direction of movement 3 relative to the floor B. The carrier 2 is provided with a coating that comprises graphite particles.

The graphite particles can be in the shape of flakes having a certain longitudinal extent. In this case, the particles are advantageously oriented so as to be perpendicular to the surface such that the ions flowing about the particles have to travel a shorter distance. In terms of the battery, this has substantial advantages, since the cell thus formed offers less resistance. There is thus less heat generation in general. Accordingly, the charging time can also be shortened by virtue of the shorter distances for the ions. Overall, the operation of such a cell is also substantially less hazardous as a result, since the reduced resistance, and thus the lower amount of heat when charging or discharging the cell, also reduces the risk of the cell overheating or even catching fire.

An orienting device 4 for orienting the particles is provided along a sub-section of the transport path. First, the coating is applied to the carrier 2 (not illustrated). The orienting device 4 generates a magnetic field which is variable in terms of time and/or location, the carrier 2, or the coating thereof, being exposed to the magnetic field. However, since the carrier 2 is composed of an electrically conductive material, this in the present case typically being a copper foil, inductive currents are created, which in turn generate a magnetic field which interacts with the magnetic field of the orienting device 4.

Since the carrier 2 here is transported in a roller-to-roller process, wherein at least one roller is configured as a driven roller, high tension as a result of this effect of force can also stress the carrier 2.

In order to be able to minimize or compensate this effect, respectively, an additional drive device 5 is provided, the latter here in the direction of movement 3 being disposed directly downstream of the orienting device 4.

FIG. 2 shows a plan view from above of the assembly from FIG. 1. As a result of magnetic induction, which emanates from the magnetic fields that are variable in terms of time or location and are generated by the orienting device, eddy currents 6 are generated in the carrier 2 (here a coated copper foil). The magnetic field resulting therefrom brakes the carrier 2, because the magnetic field interacts with the magnetic field of the orienting device 4. The braking force 7 is counter to the direction of movement 3.

In order for this effect to be equalized, an additional drive device 5 is provided, the latter in turn exerting a driving force 8 counter to the braking force 7. The drive device 5 is preferably configured for not contacting the carrier 2, thus for operating in a non-contacting manner, so as not to damage the coating of the carrier 2, or disturb the orientation of the particles contained in the latter, respectively.

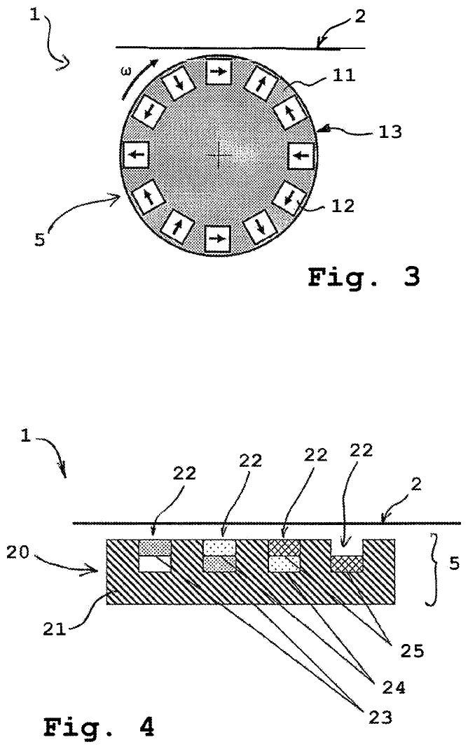

It is illustrated in FIG. 3 how such a drive device 5 can be implemented. The drive device 5, or the alternating field generator, respectively, can be configured as a magnetic roller 13; i.e. the alternating field generator here is integrated in a cylindrical roller 11, permanent magnets 12 in a Halbach array being disposed along the circumference of the cylindrical roller 11. The arrows on the permanent magnets indicate the orientation of the respective magnetic field, or of the corresponding field lines, respectively. In order to provide a temporally changing magnetic field by way of which eddy currents can be generated inductively in the carrier 2, or which can exert a Lorentz force on the charges flowing in the carrier 2 as a consequence of the eddy currents, respectively, the roller 13 rotates at the rotating speed ω, here in the clockwise direction in FIG. 3.

In order to exert high accelerations on the carrier 2 during the linear movement of the latter, the stator 20 of a linear motor can also be used as the additional drive device 5. Grooves 22, which in each case accommodate the coils 23, 24, 25, are incorporated in the iron core 21. The coils 23, 24, 25 are passed through by a phase-delayed 3-phase alternating current. The arrangement with a linear motor typically requires a high power consumption and produces a lot of heat.

### LIST OF REFERENCE SIGNS

1 Transport device
2 Carrier
3 Direction of movement
4 Orienting device
5 Additional drive device
6 Eddy currents
7 Braking force
8 Additional driving force
11 Cylinder/roller
12 Permanent magnets
13 Magnetic roller
20 Stator of a linear motor
21 Iron core
22 Groove
23, 24, 25 Coils
ω Rotating speed
B Floor

1. A transport device for transporting a carrier in the form of a foil for producing electrodes for energy accumulators, comprising at least two rollers on which the carrier is able to be borne, and of which at least one of the rollers is provided with a drive so as to, by rotating the driven roller, move the carrier along the longitudinal extent thereof and to transport the carrier from roller to roller, further comprising a drive device for generating an additional force that facilitates the transport, wherein the drive device generates an alternating magnetic field and has an alternating field generator which for inducing eddy currents in the carrier generates a temporally changing magnetic field, in order to exert a Lorentz force on the charges flowing in the carrier as a result of the eddy currents.

2. The transport device according to claim 1, wherein the alternating field generator is integrated in one of the rollers, and is disposed such that the latter is not in contact with the carrier during transport.

3. The transport device according to claim 1, further comprising an orienting device for orienting graphite particles for an electrode in lithium-ion batteries in a coating with which the carrier is provided, said orienting device generating a magnetic field that is variable in terms of time and/or location.

4. The transport device according to claim 3, wherein the orienting device is configured for generating in the carrier eddy currents in the carrier plane, the preferred directions of said eddy currents running in particular transversely to the transport direction.

5. The transport device according to claim 1, wherein the alternating field generator is integrated in one of the rollers.

6. The transport device according to claim 1, wherein the alternating field generator is configured as a rotor, at least two permanent magnets being disposed along the circumference of said rotor.

7. The transport device according to claim 6, wherein the permanent magnets are disposed in an Halbach array along the circumference such that the fields in the interior of the permanent magnets are in each case oriented so as to be tangential or radial in relation to the path of rotation in the rotation plane.

8. The transport device according to claim 6, wherein the rotor has a rotor drive device including a motor with a timing belt.

9. The transport device according to claim 8, wherein the rotor drive device is configured for varying the rotating speed of the rotor and for adapting said rotating speed to the transport speed of the carrier at a specific ratio, in particular for adapting said rotating speed such that a defined force acts on the carrier.

10. The transport device according to claim 6, wherein the rotor is mounted on a static shaft.

11. The transport device according to claim 10, wherein the rotor is mounted on the static shaft by way of at least one roller bearing.

12. The transport device according to claim 1, wherein the alternating field generator is configured as a stator of a linear motor which is disposed relative to the transport section of the carrier such that the carrier is driven as a slider.

13. The transport device according to claim 12, wherein the stator of the linear motor has at least three coils which are disposed along the transport section of the carrier and through which a mutually phase-delayed alternating current flows.

14. The transport device according to claim 13, wherein the coils are incorporated in the grooves of an iron core and/or of a laminated sheet package.

15. The transport device according to claim 1, wherein the drive device is configured for:
compensating an increase in the web tension caused by the orienting device as a consequence of magnetic induction; and/or
reducing creasing of the carrier as a consequence of the web tension.

16. The transport device of claim 13, wherein the mutually phase-delayed alternating current is 3-phase alternating current.
